(19) United States
(12) Patent Application Publication
(10) Pub. No.: US 2010/0023570 A1
(43) Pub. Date: Jan. 28, 2010

(54) Method of detection of signal homeostasis

(75) Inventors: Chethan Gururaja, Pune (IN); Vinay Vaidya, Pune (IN)

Correspondence Address: Vinay Govind Vaidya, 35 and 36, Rajiv Gandhi Infotech Park, Phase 1, MIDC, Hinjawadi, Pune, MH, 411057, IN

(73) Assignee: KPIT CUMMINS INFOSYSTEMS LIMITED, Pune (IN)

(21) Appl. No.: 12/177,928

(22) Filed: Jul. 23, 2008

(51) Int. Cl. G06F 7/38

(52) U.S. Cl. 708/440; 708/443

(57) ABSTRACT

A method for detecting steady-state convergence of noisy or noise free signal comprising the steps of calculating derivative of signal input, calculating the tan inverse of the ratio of positive and negative derivatives and validation of establishment of steady state from the arctan value thereof.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The present invention relates to the field of methods of signal processing and more particularly to methods of evaluation of steady state convergence of a signal.

2. Description of Related Art

Detecting steady state convergence of a signal when the reference value of steady state is not known is a big challenge in control systems applications. For a given input, the output of the system may settle at an unknown value.

It is imperative in control systems to determine whether a signal has attained a steady state for the purpose of enhancing overall stability of the system. The divergence of a signal from steady state is often treated as a trigger for positive or negative control over feedback systems wherein the feedback control gains may be modified, and/or the current control value may be stored for using it again when similar operating conditions are encountered again.

The detection of achievement of and divergence from steady state of a signal value is important as the variability that occurs in a converged signal is often difficult to distinguish from the variability that occurs prior to convergence. The time factor in identifying convergence of the signal is of paramount importance in deciding the priority of trouble shooting measures to be implemented.

In addition, it is even more difficult to detect steady state of a signal if the signal has low signal to noise ratio. Under noisy signal conditions, standard techniques of taking a derivative fail to give correct results.

Thus, it is a pressing need for a system that can detect and monitor maintenance of steady-state of a signal on a real time basis.

Systems and mechanisms to detect steady state convergence of signals find mention in the art.

U.S. Pat. No. 6,680,607 discloses a method to detect steady-state convergence of a signal wherein the invention is directed to detecting steady-state convergence of a signal by comparing a filtered version of the signal or its numerical derivative to a threshold over a given time interval, wherein a measure of the signal variability is used to tune the filter behavior. In the preferred embodiment of this invention, a derivative of the signal is filtered with a low-pass filter, and the cut-off frequency of the filter is adjusted in proportion to the measured variability of the signal. In another embodiment of this invention, the signal is filtered with a high-pass filter, and the cut-off frequency of the filter is adjusted inversely with respect to the measured variability of the signal. In each case, the variability of the signal is measured by computing a differential of the signal and then smoothing the differential. However, this method suffers from the drawbacks that it cannot function without filtering of the signal and that it cannot detect the frequency of the signal on a real time basis. Also, the steady state value of the signal has to be known beforehand. Thus the method to detect steady state convergence of a signal, according to this invention, is of limited applicability.

U.S. Pat. No. 4,910,465 discloses a circuit for detecting the phase of an electrical signal at a known frequency f. The said circuit initially mixes the test electrical signal with a first signal of same frequency f to generate a signal I and also mixes the test signal with a second signal of frequency f, but which is 90 degrees out of phase with the first signal, to generate a signal Q. The signals I and Q are digitized and the log of each of these digitized values is generated. The difference log Q minus log I is then generated and a means is provided for generating the Arctan of the antilog of this difference, this Arctan being indicative of the desired signal phase. More particularly, when the log I and log Q values are generated, these are the logs of the absolute values of the signals I and Q. The signs of the I signal and the Q signal are also stored and these stored signs are utilized to determine the quadrant for the signal phase. For a preferred embodiment, the log generating means includes at least one table-look-up memory and may include a separate table look-up memory for each log generation. Similarly, the Arctan generating means may also be a table look-up memory. However, this invention suffers from the drawback that it cannot ascertain whether a signal has attained steady state without prior knowledge of frequency of the test signal and phases of the same at respective steady states. Also, the circuit according to this invention cannot, by itself, measure the frequency of the test signal. These parameters become critical when the test signal has large variance in both frequency and amplitude.

Thus, the methods and systems of prior art have not been able to address the said problems and do not anticipate the invention proposed by the current inventors.

The current inventors have come up with a novel method to detect whether a signal has attained steady state, regardless of knowledge of its actual steady state value. Additionally, there may be more than one steady state value for a signal after attaining a steady state. Also, the signal may vary sinusoidally and stay within bounds. The present invention provides for a method to detect critically stable systems as steady state.

Further, stability of signals with high amount of noise is difficult to detect. It is an added advantage of the present invention that it detects steady state despite extreme amount of additive gaussian noise.

### BRIEF SUMMARY OF THE INVENTION

The present invention is directed to an improved method for detecting steady-state convergence of a noisy or noise free signal by calculating the tan inverse or the arctan value of the signal input. Signal input comprises the signal value, moving maximum and minimum of the signal and the frequency of the signal. Derivative of the signal input is calculated and ratio of the positive derivatives to the negative derivatives is calculated. The signal is said to have attained a steady state if the arctan value of the said ratio is 45 degrees. The present invention also provides for dynamic measurement of the frequency of the signal as a function of symmetry of signal and on the basis of estimation of its periodicity in passing the arctan value of steady state.

### BRIEF DESCRIPTION OF THE DRAWINGS

FIG. 1 is a block diagram of process of signal processing and mode for performing the method of the preferred embodiment of this invention.

FIG. 2 is a graph illustrating schematics of the method to ascertain whether a signal has achieved steady state.

FIGS. 3a to 3o are screen shots of Simulink scopes, with the top graph showing the input signal and the bottom graph showing whether steady state was detected or not.

Table 1 is a compilation of results of the experimentation carried out, more particularly described in example 1.

### DETAILED DESCRIPTION OF THE INVENTION

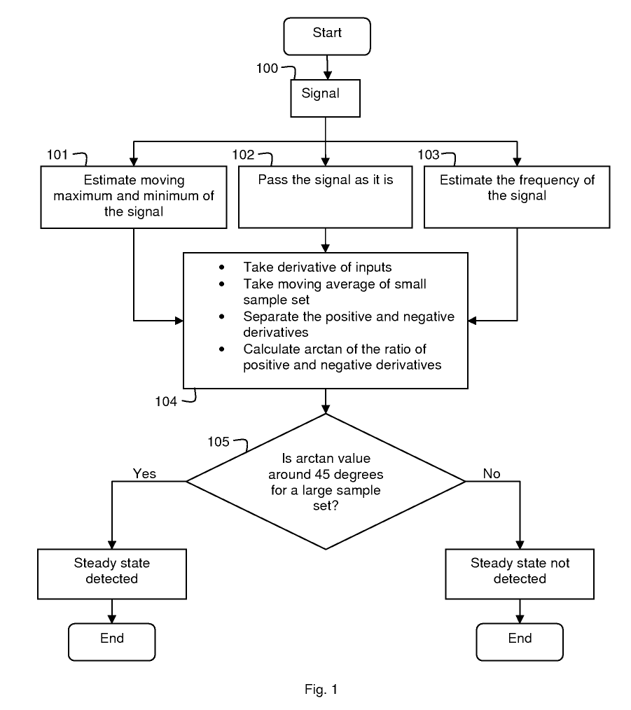

FIG. 1 is a block diagram outlining the methodology of signal processing according to the preferred embodiment of this invention. Input of signal 100 is taken as its inherent value 102, moving maximum or minimum 101 or its frequency 103. The input is treated to a signal processing system 104 wherein derivative of these inputs is calculated. Moving average of the derivative for a small sample set is then taken. The positive and negative of the values thereof are separated and arctan of ratio of the positive and negative values is calculated. The same set of operations is repeated for the moving maximum, minimum and frequency as well. If arctan values for these operations are about 45 degrees for a large number of readings and ratios thereof, the signal is said to have attained a steady state. For the signal to be in steady state, the plot should fit into a straight line making an angle of 45° with the axes. The signal is said to have attained steady state when this condition is satisfied for large sample set.

It is an advantage of the present invention that knowledge of a reference steady state value of a signal and signal to noise ratio are immaterial for detection of steady state and that if such values are actually known, they add utility to the present invention in the sense we can check whether the steady state achieved confirms to this value or not.

Frequency of a given signal may vary. Detection of real time frequency characteristics of the signal is another feature of the present invention. To dynamically detect the frequency, the positive and negative slopes of the signal are determined, sorted and tan inverse is calculated of the ratio of the positive and negative slopes. From measurement of the time elapsed between two 45 degree crossings of these tan inverse values, the period can be estimated which in turn, gives frequency of the signal, using the equation:

f=n/t (1)

Where ‘f’ is the frequency, ‘n’ is number of 45-degree crossings of the arctan values, ‘t’ is the time required for ‘n’ crossings,

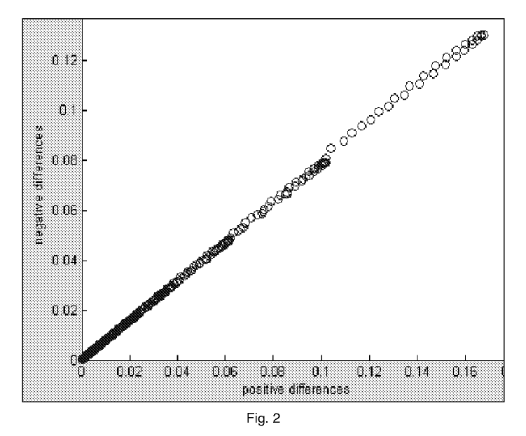

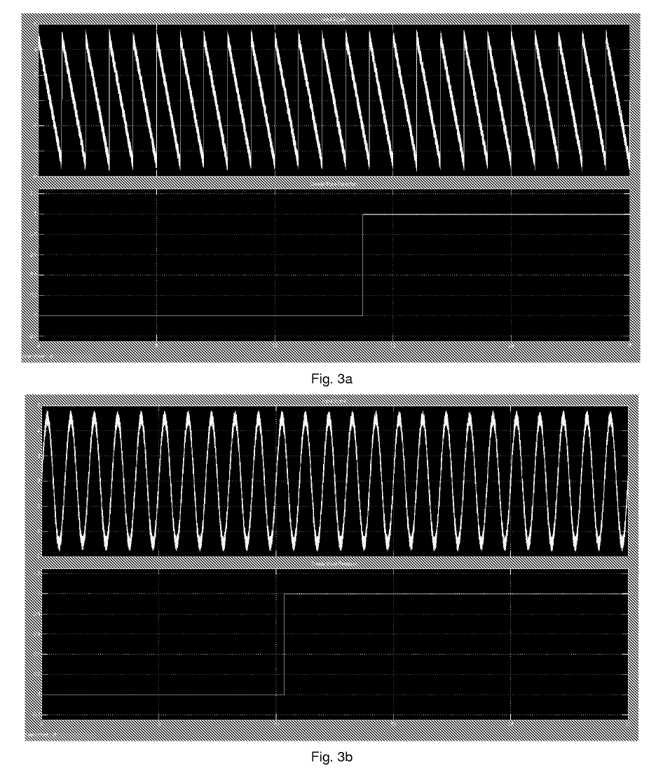

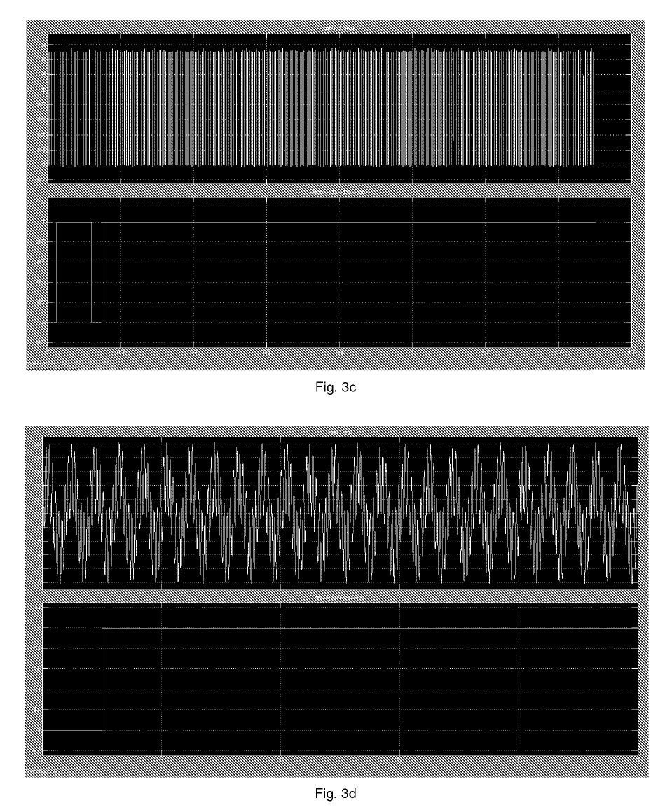

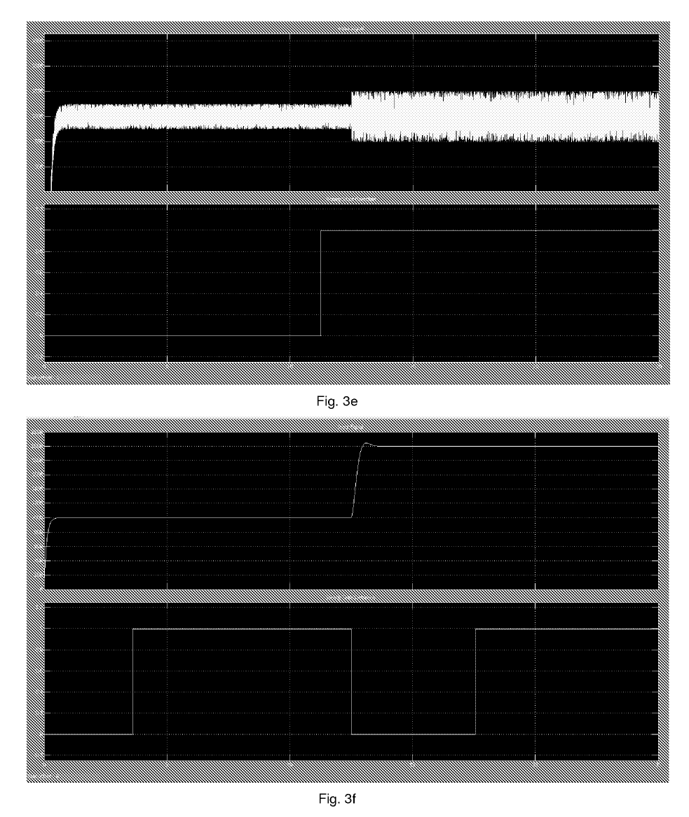

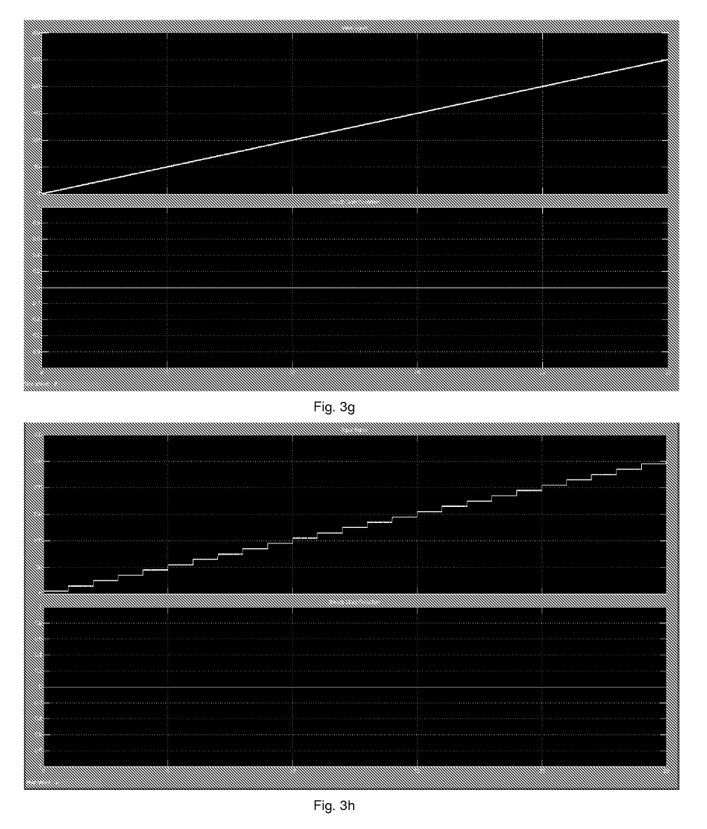

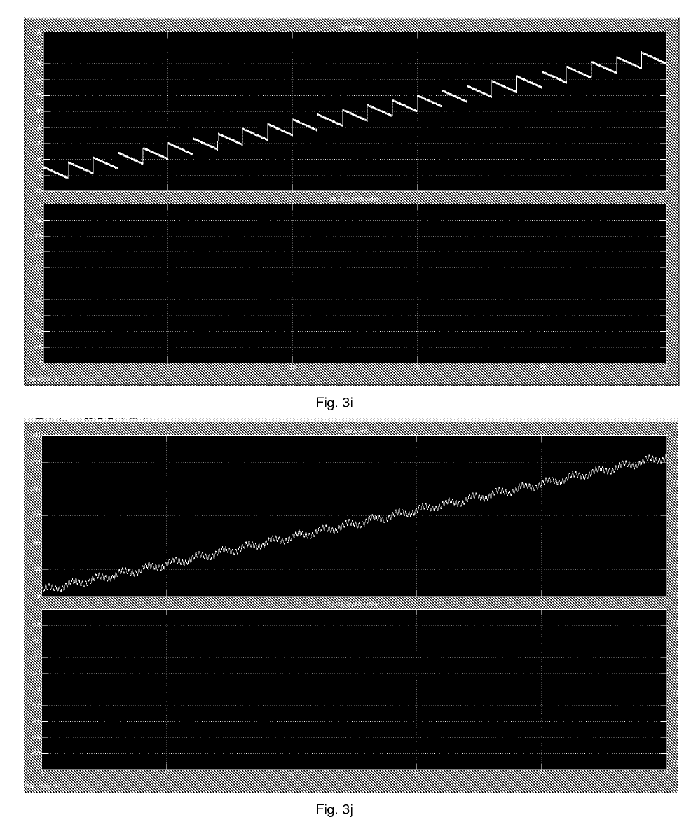

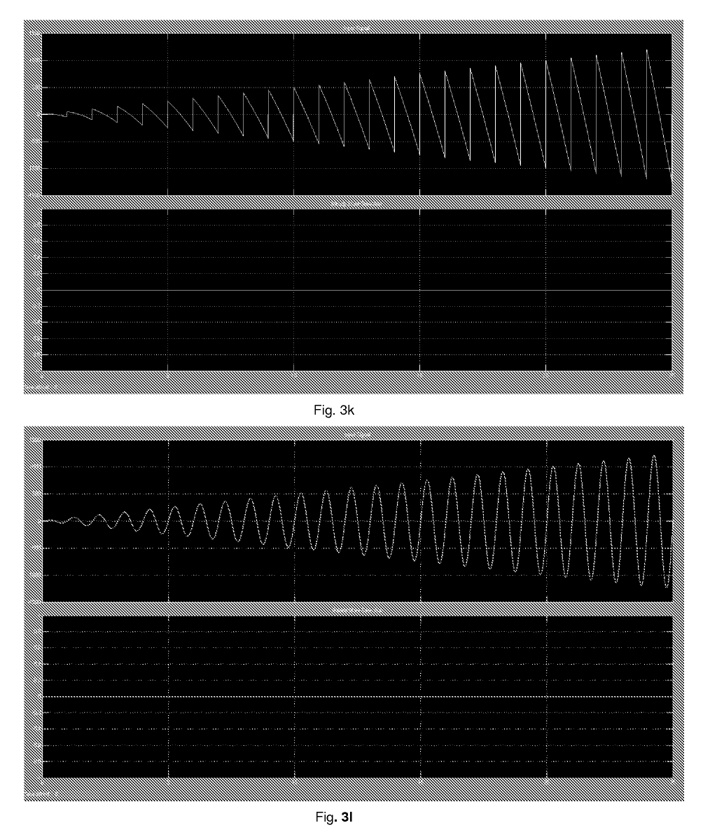

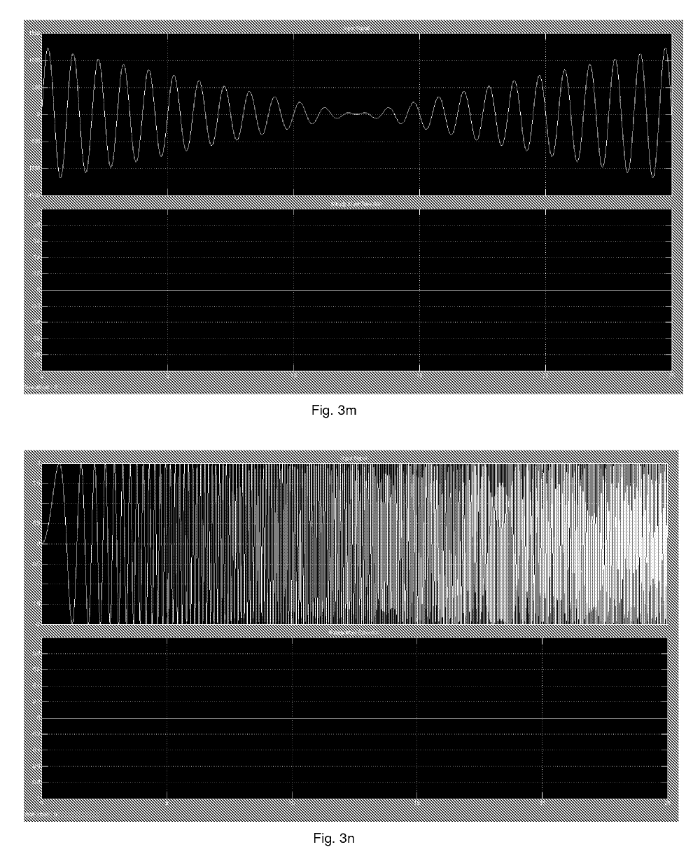

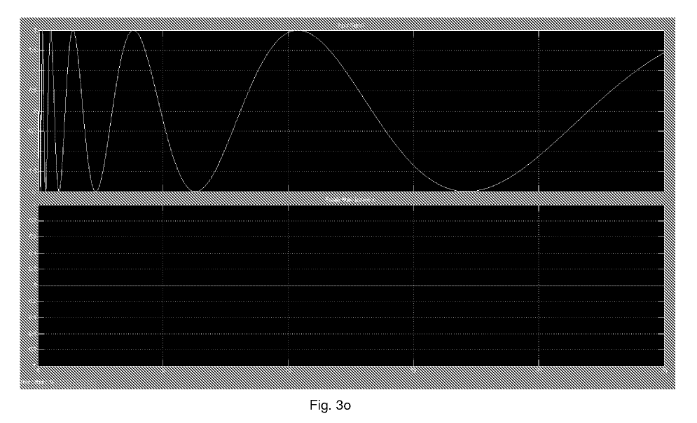

FIG. 2 is a graph illustrating achievement of steady state of signal. The positive derivatives are plotted along x axis and the negative derivatives are plotted on y axis. When a signal attains steady state, it means that it is not diverging. If it does not diverge, the magnitude of positive slope of the signal must be more or less the same as the magnitude of the negative slope of the signal, and hence, their ratio be equal or near to unity. Moreover, the moving maximum, minimum and frequency of the signal also exhibit the same condition. Thus, it is this symmetry that that the present invention exploits to determine steady state convergence of the signal, as evident from FIGS. 3a to 3o.

Thus, the present inventors have come up with methods to determine steady state convergence of signals. The present invention is also qualified by non-requirement of standard low or high pass filters and additionally providing the means for detection of frequency of the signal.

Yet other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive. Modifications and variations of the methods and devices described herein will be obvious to those skilled in the art from the foregoing detailed description. Such modifications and variations are intended to come within the scope of the appended claims.

The following example further illustrates the invention. This example is for illustration purpose only and does not limit the scope of the invention

### EXAMPLE 1

Input signal data (signal, frequency and moving maximum and minimum) was created manually and subjected to signal processing as outlined by the best mode of the present invention. FIGS. 3a to 3o illustrate plots to detect achievement of steady state wherein signals with different characteristics were used as input. X axis denotes time and Y axis denotes amplitude. Also, the top graphs illustrate input signal and the bottom graphs illustrate condition when steady state of the signal is detected. In the lower graph, if the ordinate value is one, steady state is said to be attained. Table 1 represents a compilation of results of these exercises wherein processing of input signals and detection of achievement of steady state of the signal was performed as per example 1 of the present invention

Thus, it would be evident to those skilled in the art that the method of detection of signal homeostasis, as proposed by the present invention, is robust and that there is absolutely no chance of generation of a ‘false positive’ report of achievement of steady state.

TABLE 1

| | | | Whether steady state detected/ |
|---|---|---|---|
| | Figure | Characteristics of input signal | condition |
| # | number | (Upper graph) | (Lower graph) |
| 1 | 3a | Sawtooth wave with noise and at constant | Steady state detected |
| | | frequency | |
| 2 | 3b | Sinusoidal wave with noise and at a | Steady state detected |
| | | constant frequency | |
| 3 | 3c | Square wave with initially varying frequency | Steady state detected, once |
| | | | frequency becomes steady |
| 4 | 3d | Waveform with two different frequencies | Steady state detected |
| 5 | 3e | Signal with change in noise level | Steady state detected remains |
| | | | unchanged |
| 6 | 3f | Two different steady states with no noise | Both the steady states are detected |
| 7 | 3g | Noisy ramp signal | Signal is not steady and therefore, no |
| | | | steady state is detected |
| 8 | 3h | Sawtooth on a ramp with high noise level | Signal is not steady and therefore, no |
| | | | steady state is detected |
| 9 | 3i | Sawtooth on a ramp with noise | Signal is not steady and therefore, no |
| | | | steady state is detected |
| 10 | 3j | Two sine waves on a ramp | Signal is not steady and therefore, no |
| | | | steady state is detected |
| 11 | 3k | Sawtooth wave with changing amplitude | Signal is not steady and therefore, no |
| | | | steady state is detected |
| 12 | 3l | Sine wave with changing amplitude | Signal is not steady and therefore, no |
| | | | steady state is detected |
| 13 | 3m | Sine wave with changing amplitude | Signal is not steady and therefore, no |
| | | | steady state is detected |
| 14 | 3n | Sine wave with no noise and increasing | Signal is not steady and therefore, no |
| | | frequency | steady state is detected |
| 15 | 3o | Sine wave with no noise and decreasing | Signal is not steady and therefore, no |
| | | frequency | steady state is detected |

We claim:

1. A method to detect steady-state convergence of a signal of a control system wherein the exact value of steady state of the signal is not known, the method comprising the steps of:
recording signal inputs;
calculating derivative of the signal inputs;
taking ratio of positive and negative derivatives;
calculating the tan inverse value of the ratio of positive and negative derivatives; and
validating achievement of achievement of steady state from recorded tan inverse values.

2. The method of claim 1 wherein the signal may be noisy or noise-free.

3. The method of claim 1 wherein recording of signal inputs comprises recording the value of signal, moving maximum and minimum of the signal and frequency of the signal.

4. The method of claim 1 wherein the process of detection of the signal frequency further comprises steps of
recording positive and negative slopes of signal;
separating positive and negative slopes;
calculating ratio of slopes by dividing the positive slope value by negative slope value;
calculating the tan inverse of ratio of slopes;
recording time period elapsed between two consecutive times when value of tan inverse of ratio of slopes crosses forty five degrees; and
calculating the frequency of the signal by dividing total number of said crossings by total time to get number of crossings per unit time.

5. The method of claim 1 wherein the calculation of the arctan value comprises calculation of the tangent inverse function of the signal input.

6. The method of claim 1 wherein the validation of achievement of steady state by the input signal comprises the step of ascertaining whether the calculated value of the arctan ratio is equal to 45 degrees.

7. The method of claim 1 wherein the signal is said to have achieved stead state when calculated value of the arctan ratio is equal to 45 degrees.

8. The method according to claims 1-7 as substantiality described in the description and illustrated in figures attached alongwith.
